(19) United States
(12) Patent Application Publication
(10) Pub. No.: US 2020/0090094 A1
(43) Pub. Date: Mar. 19, 2020

(54) HARVESTER CONTROL SYSTEM

(71) Applicant: Deere & Company, Moline, IL (US)

(72) Inventor: Sebastian Blank, Moline, IL (US)

(21) Appl. No.: 16/135,416

(22) Filed: Sep. 19, 2018

(51) Int. Cl. G06Q 10/06; G06Q 50/02; A01B 79/00; G06Q 50/28

(52) U.S. Cl. CPC G06Q 10/06315; G06Q 50/02; A01D 45/10; G06Q 50/28; A01B 79/005

(57) ABSTRACT

A detector detects yield data corresponding to a plurality of different harvesters. Detectors can also detect harvest performance data and logistics performance data for those harvesters. A control signal generator generates control signals to control the harvesters to maintain a target harvest rate, for the crop harvested by the plurality of harvesters, collectively.

### FIELD OF THE DESCRIPTION

The present description relates to mobile equipment. More specifically, the present description relates to controlling the operation of harvesting equipment to obtain a desired rate at which a crop is harvested.

### BACKGROUND

There are many different types of agricultural machines. Some machines include harvesters, such as combine harvesters, sugarcane harvesters, forage harvesters, etc. Controlling these types of harvesters is often quite complicated. An operator may provide a wide variety of different types of inputs to control a variety of different types of subsystems on the harvester.

It may also be, in some scenarios, that the harvesters operate most efficiently when they harvest crop at a desired rate (so that the rate at which the crop is harvested is relatively constant, or matches a target rate). Controlling the harvesters, especially where there are multiple harvesters, to harvest at a desired rate can be quite difficult.

The discussion above is merely provided for general background information and is not intended to be used as an aid in determining the scope of the claimed subject matter.

### SUMMARY

A detector detects yield data corresponding to a plurality of different harvester. Detectors can also detect harvest performance data and logistics performance data for those harvesters. A control signal generator generates control signals to control the harvesters to maintain a target harvest rate, for the crop harvested by the plurality of harvesters, collectively.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram of one example of a harvesting system architecture.

FIG. 2 is a block diagram showing one example of a harvester control computing system in more detail.

FIG. 3 is a flow diagram illustrating one example of the operation of the harvest control computing system in generating control signals to control harvesters based on a harvest rate.

FIG. 4 is a flow diagram illustrating one example of the operation of the harvester control computing system in generating output yield data based on detected yield metrics.

FIG. 5 is a flow diagram illustrating one example of the operation of the harvester control computing system in generating harvest performance data based on detected productivity metrics.

FIG. 6 is a flow diagram illustrating one example of the harvester control computing system in generating logistics performance data based on detected logistics metrics.

FIG. 7 is a block diagram showing one example of the architecture illustrated in FIG. 1, deployed in a remote computing architecture.

FIG. 8 is a block diagram showing one example of a computing environment that can be used in the architectures illustrated in the previous figures.

### DETAILED DESCRIPTION

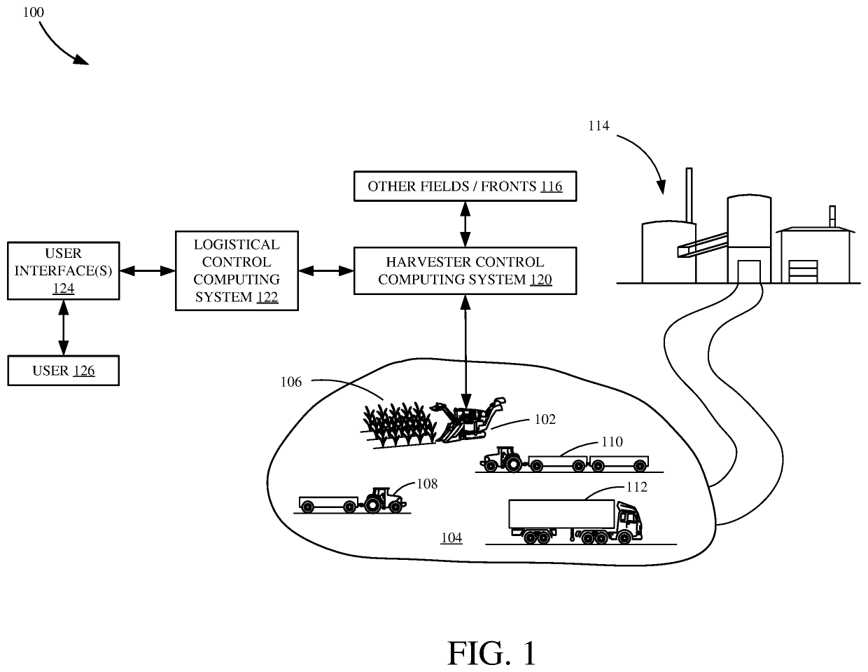

FIG. 1 is one example of a harvesting system architecture 100. Architecture 100 is shown in a scenario in which the harvested material comprises sugarcane 106. Architecture 100 includes one or more harvesters 102, each of which is supported by one or more support vehicles 108-110 (which, in the scenario illustrated, includes tractors pulling one or more billet wagons). A trailer truck 112 receives harvested material (sugarcane billets) from support vehicles 108-110 and transports it to a processing facility (such as mill 114). A conventional sugarcane mill 114 may take harvested sugarcane from multiple different fields 104 surrounding the mill 114, in order to maintain a constant rate of production through the mill 114. If the mill 114 runs out of sugarcane to process, then the cost per ton of sugarcane that is processed at the mill increases drastically. Therefore, it is often desired to have some amount of buffer crop at the mill 114, while receiving crop at a target rate that keeps the size of the buffer relatively constant. The buffer crop must not grow too large, because sugarcane is perishable. For instance, in some cases, if it is not processed within 24 hours of being harvested, it is discarded because its chemical structure changes and gives it undesirable characteristics for sugar production. If the buffer is too small, then the mill 114 may run out of cane to process, rendering the mill operation highly inefficient.

The logistics involved in maintaining a relatively constant rate of sugarcane delivery to the mill 114 for processing can be very complicated. A representative set of sugarcane harvesting equipment may include, for example, fifteen harvesters 102, thirty tractors, sixty billet wagons, and seven highway trucks (or trailer trucks) 112. A plurality of different sugarcane harvesters 102 (say, for example, three harvesters) may be harvesting sugarcane in a single field 104. For each harvester 102 in the field 104, there may be two tractors each pulling two wagons. The field may have one or more highway trucks 112. A harvester 112, and its support vehicles 108-110 (such as two tractors and four billet wagons) is referred to as “front”.

The harvesting process includes cutting the cane at the base, stripping the leaves, cutting the cane stalks into usable “billets”, and depositing the billets into a tractor-drawn billet wagon that travels alongside the harvester 102. When the billet wagon reaches a desired capacity, the harvester 102 may stop the harvesting process to allow the billet wagon to depart and a second tractor-drawn billet wagon to be positioned alongside the harvester to receive the harvested crop. The full billet wagon is transported to a larger capacity trailer truck 112 and the crop is transferred from the billet wagon to the trailer truck 112. The billet wagon is then towed to a location where it is ready to be positioned for receiving billets from one of the working harvesters 102 in the field 104.

The trailer truck 112 either remains at its location to receive additional crop from other billet wagons, or it may travel to another location to receive additional crop from billet wagons in the same field 104, or in a different field. When the trailer truck 112 reaches a desired capacity, it is transported to a larger storage or processing area, such as sugarcane mill 114. After unloading the crop, the trailer truck 112 travels to its previous location, or to a new location, to receive additional crop loads from the billet wagons.

Some operations of this type have a field manager (e.g., user 126) that coordinates the vehicle logistics. The field manager attempts to maintain communication with the sugarcane mill 114, the cane harvesters 102, and all of the various supporting vehicle operators and the driver of trucks 112 to determine current vehicle locations, vehicle status, and resource needs. Transfer vehicles, such as billet wagons and trailer trucks, are directed to locations based upon actual or anticipated harvester locations. Additionally, the field manager attempts to use as few vehicles as are necessary, with minimal operator downtime.

Current systems that are used in order to maintain a desired crop rate at the mill 114 involve the manager, or an operator, providing an indication of a likely yield from a field 104. The indication is relatively coarse, such as a ranking indicative of a high, medium, or low likely yield from that field. The manager then attempts to coordinate different fronts in different fields 104, 116, so that the harvest rate of sugarcane is relatively constant, and is close to a desired harvest rate which is correlated to the timing of delivery of harvested billets to the mill 114. This is open loop, imprecise, and highly error prone. It can result in mill downtime (because the mill 114 runs out of cane to process) and it can result in crop loss (because the crop is not processed within a desired time window of when it was harvested).

Therefore, in one example, architecture 100 also includes harvester control computing system 120. Harvester control computing system 120 illustratively detects (or obtains) values for a number of different variables indicative of different characteristics that are correlated to harvest rate. For instance, it illustratively detects (or obtains) yield data indicative of a likely yield within field 104. In one example, the yield data can be for an entire field 104, or for different areas of field 104, based upon the location of the different harvesters 102 within field 104. Harvester control computing system 120 also illustratively detects (or obtains) harvest performance data for the different harvesters 102 that are being used in field 104 or in other fields or fronts 116. The harvest performance data is illustratively indicative of a current or estimated harvest rate for a particular harvester, given its operator and given the operators of the other equipment in the front corresponding to (or supporting) that harvester.

Harvester control computing system 120 also detects (or obtains) logistics performance data indicative of how well the operators of a particular harvester and the support equipment on its front, perform logistically. For instance, the logistics performance data may indicate a percent of the time that the front is actually harvesting, as opposed to being in a state in which it is not harvesting (e.g., refueling, relocating to a different part of the field, sitting idle waiting for a billet wagon, etc.). System 120 then illustratively generates control signals to control harvester 102 and it can control the other equipment 108-110 or 112. It can generate control signals to control equipment in other fields or fronts 116 as well, in order to maintain a desired harvest rate or rate of delivery of harvested material to mill 114.

In one example, system 120 also generates control signals and provides them to logistical control computing system 122 which generates user interfaces 124 for interaction by user 126. User 126 may be a front manager, or a manager that manages multiple fronts, or a different user. In one example, logistical control computing system 122 provides user input mechanisms on user interfaces 124 so that user 126 can interact with those mechanisms in order to control the various equipment in architecture 100, in order to generate messages for the various operators in architecture 100, or to perform other functions.

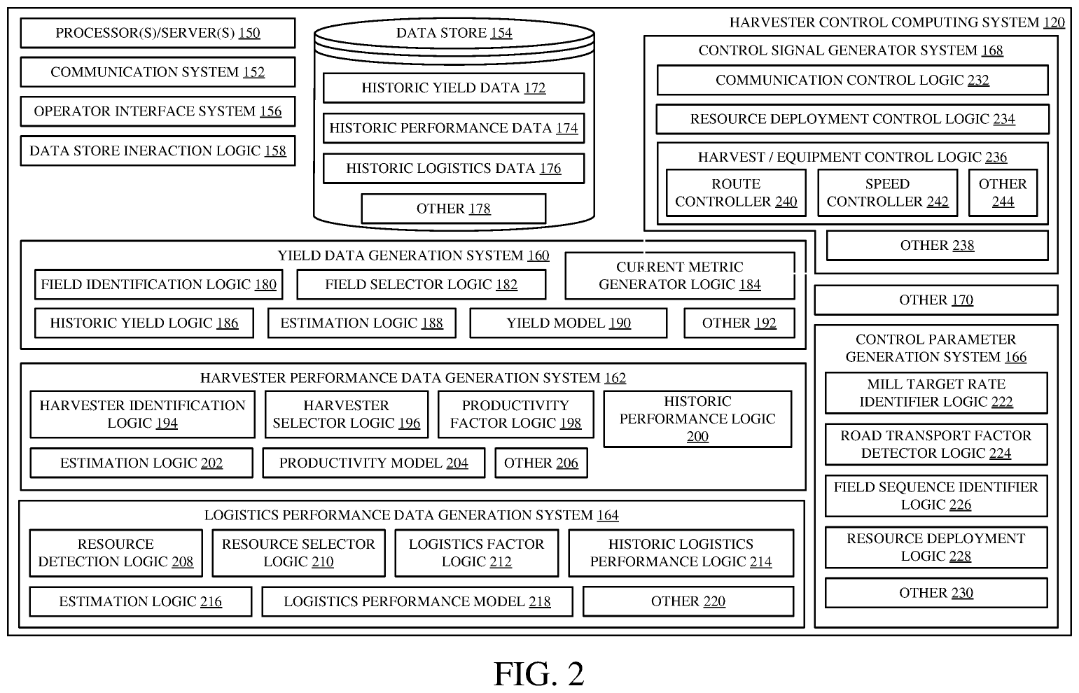

FIG. 2 is a block diagram showing one example of harvester control computing system 120, in more detail. In the example shown in FIG. 2, system 120 illustratively includes one or more processors or servers 150, communication system 152, data store 154, operator interface system 156, data store interaction logic 158, yield data generation system 160, harvester performance data generation system 162, logistics performance data generation system 164, control parameter generation system 166, control signal generator system 168, and it can include other items 170. In the example shown in FIG. 2, data store 154 illustratively includes historical yield data 172, historical performance data 174, historic logistics data 176, and it can include other items 178. Historical yield data 172 illustratively identifies yield metrics that indicate the yield obtained from different fields having different field identifiers. The field identifiers may be unique identifiers, such as geospatial coordinates, boundaries for the fields, among other things. The yield metrics may identify yield values obtained for an entire field, or for individual locations within the field. The yield metrics may be aggregate metrics which indicate a yield for the corresponding area, aggregated over different years (such as averaged over a rolling set of years), or they may be individual metrics identifying individual yield levels for the different years, (for different crops), under different crop and field conditions, etc.

The historic performance data illustratively includes performance metrics that identify the performance of a particular harvester, and/or harvester/operator combination. It may also include performance data for a particular harvester, given a particular operator, and given the equipment and operators on the other equipment of the front to which the harvester belongs. The performance data may be indicative of a yield (such as tons per hectare, etc.) or productivity (such as tons per hour), for the particular harvester, given a particular configuration, with an operator, supported by other equipment and operators on the front, etc. The performance data may be broken out into individual metrics for different geographic locations, under different field or weather conditions, for different times of the day, among other things.

The historic logistics data 176 illustratively includes metrics indicative of a percent of time that a given harvester, harvester/operator combination, or other combinations (such as those discussed above with respect to the performance data) were actually harvesting. For instance, it may indicate the percent of time, on a per shift level, that this particular harvester or harvester/operator combination were actually harvesting as opposed to redeploying within a field, sitting idle waiting to unload or waiting for a billet wagon, or in other states in which it is not harvesting. The historic logistics data can be data generated from within a field historically or across numerous fields over a season or from a subset of fields based on various properties, among other things.

Yield data generation system 160 illustratively includes field identification logic 180, field selector logic 182, current metric generator logic 184, historic yield logic 186, estimation logic 188, yield model 190, and it can include other items 192. Field identification logic 180 illustratively identifies a field for which data is to be obtained and processed. It can receive an input from an operator or manager indicating a field for which data is to be processed. It can also receive an input indicating the geographic location of harvester 102 or other equipment and identify a field that contains that geographic location. It can obtain field identification data from data store 154 which indicates not only a field identifier, but a unique identifier that identifies the geographic location (e.g., boundaries) of the field. It can identify the field in other ways as well.

Field selector 182 selects a field for processing, where more than one field is to be processed. Current metric generator logic 184 identifies current metrics from the field that bear upon yield. For instance, they can receive information from a yield detector on harvester 102 or other equipment indicative of a current yield being experienced within the field. Historic yield logic 186 illustratively uses data store interaction logic 158 to obtain historic yield data 172 for the selected field. Estimation logic 188 can generate an estimate of the yield for the field, or individual portions of the field, based on the information received. Yield model 190 illustratively receives the information generated or obtained by other components and generates yield information indicative of expected yield from a field being processed. It can provide this information along with a yield value indicative of a quantity per hectare or another measure of the yield. In addition, model 190 can illustratively aggregate information from various fields to identify the yield value that will be generated by various fronts, in different fields, over a given period of time (such as over a shift, over a day, etc.).

Harvester performance generation system 162 illustratively includes harvester identification logic 194, harvester selector logic 196, productivity factor logic 198, historic performance logic 200, estimation logic 202, productivity model 204, and it can include other items 206. Harvester identification logic 194 illustratively generates harvester identification information indicative of a particular harvester 102 that is being used in a field under analysis. It may identify multiple different harvesters in a single field or in multiple different fields, that are to be used. Harvester identification logic 194 illustratively identifies the harvester, its model, size, configuration, etc. It can do this by receiving an operator input indicative of the harvester information, or by receiving information from electronic or other components on the harvester 102 itself, or by using data store interaction logic 158 to extract harvester identification information from data store 154 or elsewhere.

Harvester selector logic 196 selects a harvester to be analyzed, when multiple harvesters are being processed. Productivity factor logic 198 obtains additional information that may bear upon the productivity of a particular harvester, or set of harvesters, under analysis. For instance, it may detect field conditions, weather conditions, crop maturity level, or other information. This information can be detected based upon user or operator inputs, or it can be detected from detectors that are deployed to detect these variables. The detectors can be on harvester 102 or any other equipment in a field, or they can be on unmanned aerial vehicles, or unmanned ground vehicles. These are examples only.

Historic performance logic 200 can use data store interaction logic 158 to obtain historic performance data 174 for this harvester or group of harvesters as well. It can obtain historic performance data for this group of harvesters, under the current or expected field and weather conditions, crop conditions or using other factors to identify relevant performance information.

Estimation logic 202 can illustratively estimate a performance metric for this harvester or group of harvesters, where, for instance, no historic data exists, where insufficient historic data exists, or where the estimation may be more accurate, given the sensed productivity factors and harvester.

Productivity model 204 illustratively receives the information obtained or generated by other items in system 162 and generates a productivity metric indicative of the productivity of a particular front, group of fronts, harvester, harvester/operator combination, etc. It generates the productivity metric given the other sensed or obtained factors, such as the field location, the topography of the field or other field conditions, the weather conditions, crop conditions, etc. In addition, where multiple harvesters or fronts are being analyzed, productivity model 204 can aggregate information corresponding to those harvesters or fronts to obtain an aggregate productivity value as well.

Logistics performance data generation system 164 illustratively includes resource detection logic 208, resource selector logic 210, logistics factor logic 212, historic logistics performance logic 214, estimation logic 216, logistics performance model 218, and it can include other items 220. Resource detection logic 208 illustratively identifies the particular resources for which processing is being conducted. The resources can include the particular harvesters, operators, tractors, billet wagons, trucks, and other resources. Resource selector logic 210 illustratively selects a set of resources (such as a front) for which logistics performance is to be analyzed. Logistics factor logic 212 obtains or detects other factors that may bear on logistics performance. For instance, it may detect or obtain factors indicative of how far a particular field is from the mill, where a particular front is harvesting in a given field, how far the fields are from one another (which bears on how long it will take a truck 112 to travel between fields, if that is taking place), among other things. Historic logistics performance logic 214 can use data store interaction logic 158 to obtain historic logistics data 176 for the particular set of resources (e.g., the front) that is being analyzed. This information may indicate the logistics performance (such as the percent of the time that the front is actually performing harvesting operations) or other logistics performance data for this particular set of resources (the set of equipment and their operators) under similar conditions (such as under current conditions or in a similar field, under similar field, crop and weather conditions, etc.).

Estimation logic 216 can estimate logistics performance data for this front, where the historic data is absent or insufficient. It can also estimate the logistics performance for this front based on currently detected variables, such as the current yield of a field that is being harvested, the current performance of the operators of the various machines in the front, etc.

Logistics performance model 218 receives the inputs obtained or generated by the other items in system 164 and generates logistics performance data indicative of a percent of time that a front or set of fronts will actually be harvesting, or other logistics performance data. It can do so for a single front, or it can aggregate the information and generate logistics performance data for a plurality of different fronts.

Control parameter generation system 166 receives the yield data, harvester performance data, and logistics performance data from systems 160, 162, and 164, respectively, and generates control parameters that can be used by control signal generator system 168 to generate control signals to control various aspects of architecture 100 (shown in FIG. 1) to achieve a desired harvest rate. Control parameter generation system 166 illustratively includes mill target rate identifier logic 222, road transport factor detector logic 224, field sequence identifier logic 226, resource deployment logic 228, and it can include other items 230. Mill target rate identifier logic 222 illustratively identifies a target rate for one or more different mills that are receiving product from the fronts under analysis. The mill target rate identifier logic 222 can use data store interaction logic 158 to obtain historic mill target rate information from data store 154 or elsewhere. It can receive an input from an operator or manager or other user that indicates the mill target rate. It can also receive automated responses from mill 114 that are indicative of the rate at which it is processing the harvested material. It can detect the mill target rate in other ways as well.

Road transport factor detector logic 224 illustratively identifies any time delays or other factors based on the roadways over which the harvested material is transported from the harvesters to the mill 114. For instance, there may be a transport time, within a field 104 where the harvester 102 is harvesting a long distance from the roadway that will be used by truck 112. Similarly, there may be a transport factor based on the distance that the field is from mill 114, and based upon the types of roadways that will be used (e.g., whether they are gravel or dirt roads, smooth paved roads, the speed limit on those roads, the repair state of those roads, among other things).

Field sequence identifier logic 226 illustratively generates a field sequence indicative of a sequence of fields that are being harvested by various different fronts, from which harvested material should be transported to mill 114. By way of example, it may be that given the logistics, harvester performance and yield data, two loads from one field will be transported to mill 114 in the same time that a single load from a different field will be transported to mill 114. The field sequence can be generated in a wide variety of different ways in order to obtain a relatively smooth flow rate of harvested material from the various fields and fronts where the material is being harvested, to the mill 114 (or set of mills) that is receiving the harvested material.

Resource deployment logic 228 then generates control signals indicative of which equipment should be deployed to which fields and front locations. For instance, it may be that there are three tractors pulling billet wagons in a field that is being harvested by two harvesters. In that case, control signals may be generated by deployment logic 228 to control the tractors (or to send a route to the tractor drivers) indicating which harvester they should drive to at which times. Similarly, it may be that a single truck 112 services multiple different fields and may be moved to different locations even within a single field. In that case, deployment logic 228 generates control signals indicating where truck 112 should move, and when.

The various different control parameters generated by system 166 can be provided to control signal generator system 168. Control signal generator system 168 illustratively includes communication control logic 232, resource deployment control logic 234, harvester/equipment control logic 236, and it can include other items 238. Communication control logic 232 illustratively controls communication system 152 to generate communications with various operators, users, managers, mill operators, etc. The communications can direct those operators where to deploy various equipment. The communications can indicate the various harvest rates (or flow rates of harvested material) being produced by a particular harvester, a group of harvesters, a field, a front or set of fronts, etc. They can instruct an operator to change routes, speeds, etc.

Resource deployment control logic 234 illustratively generates deployment signals indicating where different pieces of equipment should be deployed, and when. These signals can take the form of automated control signals that automatically control the equipment to move to those locations at the desired times, or they can take the form of mapping control signals that generate a navigation map that is sent to, and displayed on, the equipment so that the operators can move the equipment as indicated. The control signals can take a wide variety of other forms as well.

Harvester/equipment control logic 236 illustratively generates control signals to control the harvesters 102 or other equipment in different ways. For instance, route controller 240 generates a route control system indicative of a route that a harvester 102 should take. Speed controller 242 generates a speed control signal that controls the speed of the harvester. Other control signal generators 244 can generate other control signals as well.

By way of example, where it is determined that a set of fronts has completely harvested a field and is now being deployed to a different field, this may indicate that the set of fronts on a different field must go faster to increase the rate of harvested material being delivered from that field to the mill, so that the harvest rate of material received at the mill remains relatively constant. In that case, route controller 240 may identify a route so that the harvesters 102 in the field being harvested move to the most productive areas of that field (where the yield is estimated to be the highest). Speed controller 242 illustratively generates speed control signals to increase the speed of the harvesters 102, or other equipment, to increase the overall harvest rate for that field so that the rate at which material is received at the mill 114 remains constant. These are only two examples. The opposite is also true. If there are multiple fronts harvesting in different fields that have relatively high yield, so that a buffer of material is increasing at the mill 114, then the route controller 240 and speed controller 242 can generate control signals to control the harvesters and other machines to slow down or decrease their harvest rate so that the buffer crop at the mill 114 does not get so large that the processing delay is too large, resulting in wasted material.

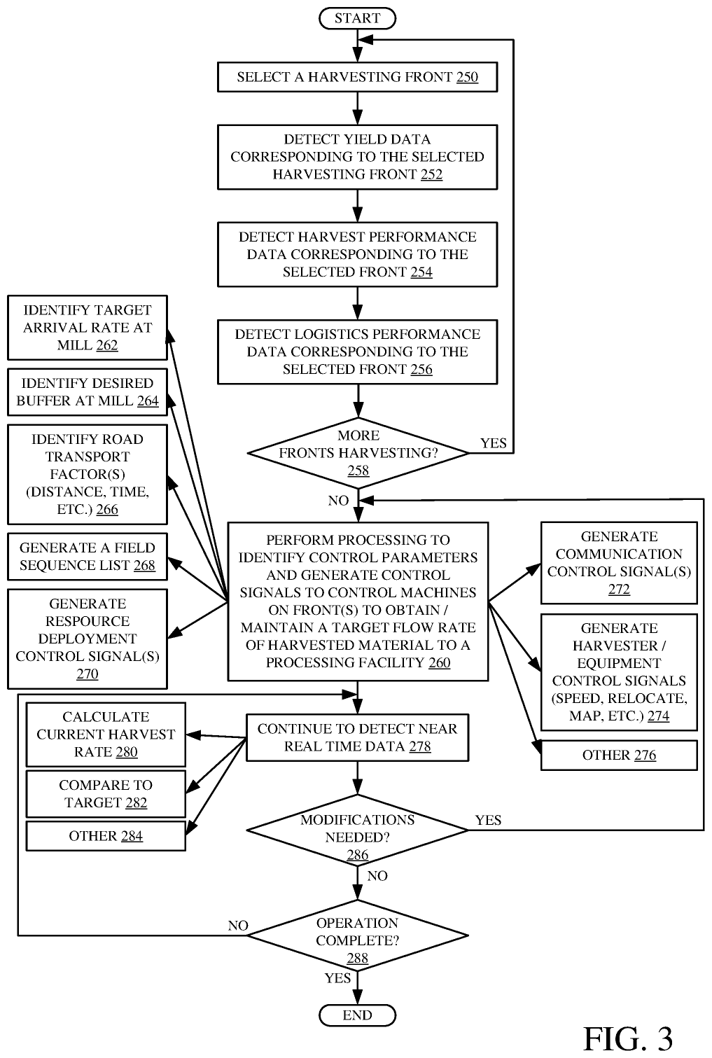

FIG. 3 is a flow diagram illustrating one example of the overall operation of harvester control computing system 120. In FIG. 3, it is first assumed that one or more fronts are harvesting, or are about to harvest in one or more different fields. Therefore, harvester control computing system 120 first selects one of the fronts for which harvesters are to be to achieve upon a target harvest rate. Selecting a harvesting front is indicated by block 250 in the flow diagram of FIG. 3. In one example, the fronts may be predefined (in terms of the specific pieces of equipment, operators, equipment/operator combinations, etc.). In another example, the fronts are identified by inputting the various pieces of equipment (such as harvesters, tractors, etc.) and identifying the operators of those items. Selecting a harvesting front can be done in other ways as well.

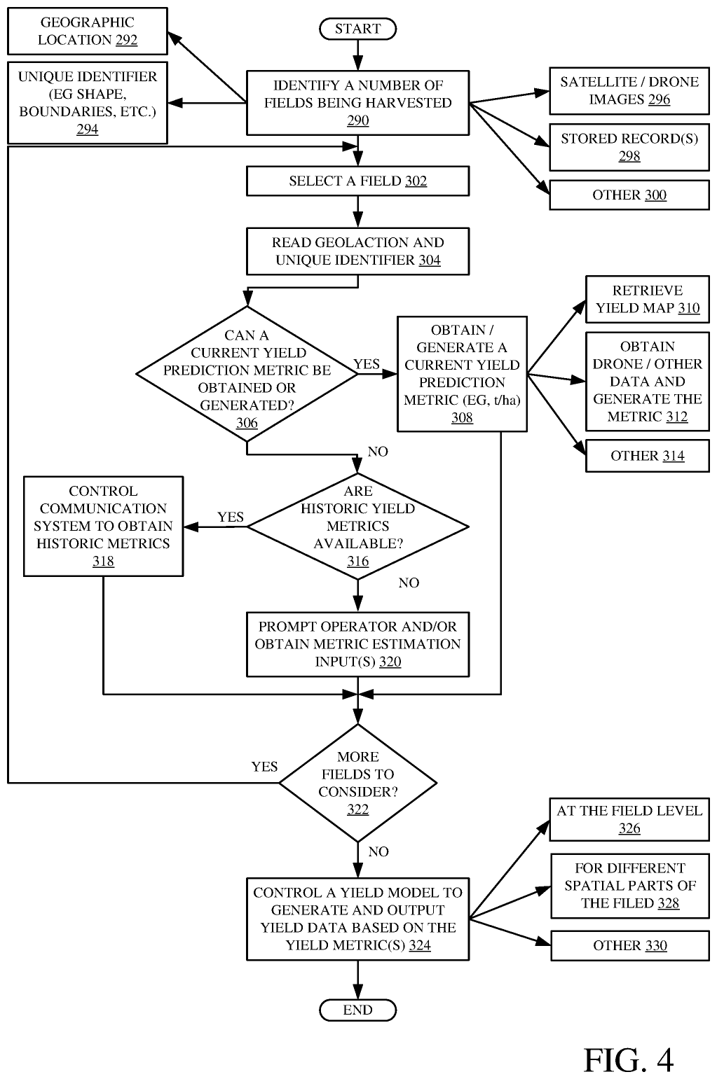

Yield generation system 160 then detects or generates yield data corresponding to the selected harvesting front. This was described, by way of example, above. It is described in more detail below with respect to FIG. 4. Detecting the yield data corresponding to the selected harvesting front is indicated by block 252 in the flow diagram of FIG. 3.

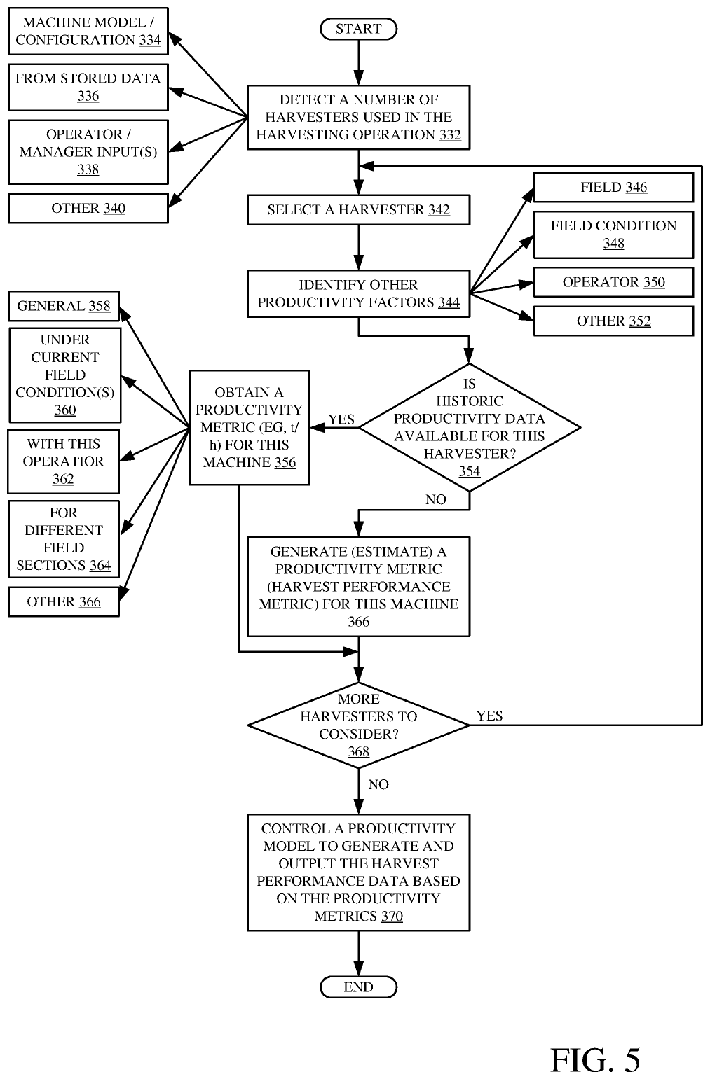

Harvester performance data generation system 162 then detects or generates harvest performance data corresponding to the selected front. This is indicated by block 254. This was also described, briefly, above, and is described in greater detail below with respect to FIG. 5.

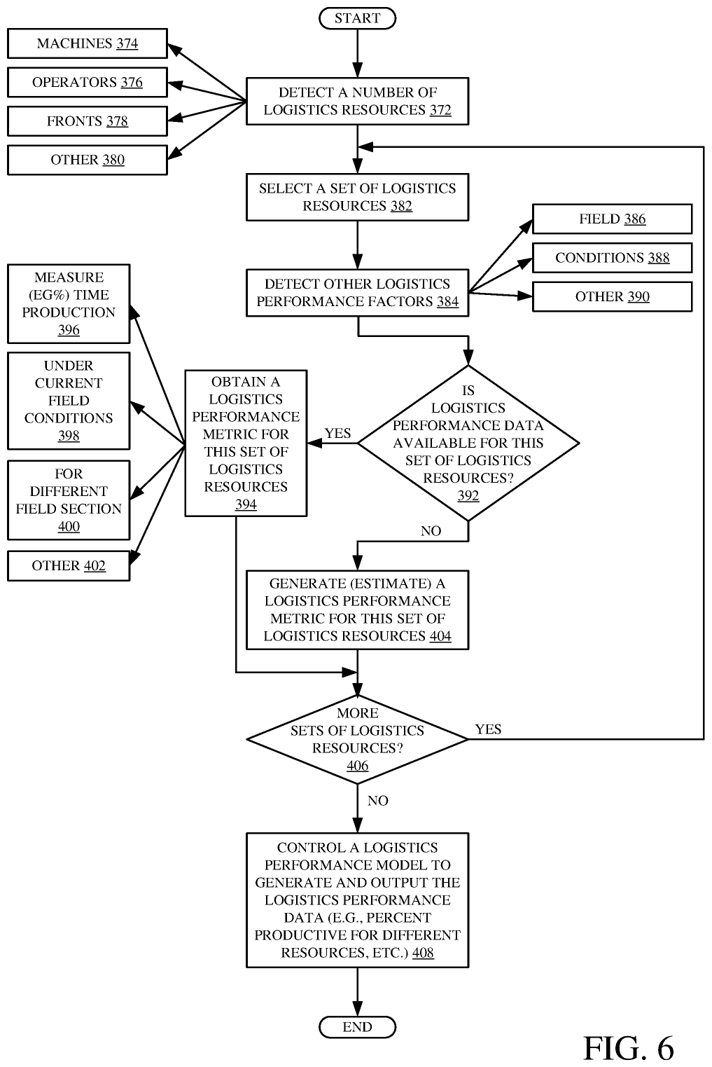

Logistics performance data generation system 164 then detects or generates logistics performance data corresponding to the selected front. This is indicated by block 256 in FIG. 3. It was described briefly above and is described in more detail below with respect to FIG. 6.

If there are more fronts performing harvesting operations, then harvester control system 120 selects the next front, and systems 160, 162 and 164 detect or generate yield data, harvester performance data and logistics performance data for those fronts. This is indicated by block 258 in the flow diagram of FIG. 3.

Once the yield data, harvester performance data and logistics performance data has been detected or generated for all of the fronts, it is provided to control parameter generation system 166. System 166 processes that information to identify control parameters and provides them to control signal generator system 168. System 168 generates control signals to control machines on the various fronts in order to obtain or maintain a target flow rate of harvested material to a processing facility (such as to one or more mills 114). This is indicated by block 260 in the flow diagram of FIG. 3. By way of example, mill target rate identifier logic 222 can identify the target arrival rate of harvested material at the mill 114. Control parameter generation system 166 generates control parameters in an attempt to maintain that rate. Identifying the target rate of material arriving at the mill is indicated by block 262 in the flow diagram of FIG. 3.

Logic 222 can also identify a desired buffer at the mill. This is indicated by block 264. For instance, in order to ensure that mill 114 does not run out of harvested material to process, the flow rate of material to the mill is controlled so that there is a buffer which is some predefined (or dynamically determined) amount of harvested material that is waiting to be processed, at the mill. Logic 222 can be used to identify the amount of the buffer, to keep it relatively constant.

Road transport factor detector logic 224 then identifies or detects any road transport factors which may affect the ability to maintain the desired flow rate of harvested material to the mill. These can be things such as distance of the harvesting material from the transport truck, distance of the field from the mill, road conditions, the time it will take to transport material, among other things. This is illustrated by block 266 in the flow diagram of FIG. 3.

Field sequence identifier logic 226 then generates a field sequence list indicative of the fields from which harvested material will be transported to mill 114, in sequence. Generating the field sequence list is indicated by block 268 in the flow diagram of FIG. 3.

Resource deployment logic 228 then generates resource deployment control signals to control various pieces of equipment to deploy them to desired locations. This may include relocating a front to a different portion of a field or to a different field all together. It may include relocating individual pieces of equipment within a front (such as tractors and billet wagons, etc.). These and other deployment control signals are generated to move equipment where needed, in order to maintain the target harvest rate of harvested material being transported to the mill. Once the parameters are generated, resource deployment control logic 234 generates resource deployment control signals to move the equipment as identified by the resource deployment logic 228. Generating the resource deployment control signals is indicated by block 270 in the flow diagram of FIG. 3.

In addition, communication control logic 232 can generate control signals to control communication system 152. The communication system 152 can be controlled to generate alerts, instructions, to send maps, route information, speed information, settings change information, or a wide variety of other information. The information can be displayed or otherwise communicated to an operator in order to modify the operation of his or her machine either manually, or automatically, in order to maintain the desired harvest rate. Generating communication control signals is indicated by block 272 in the flow diagram of FIG. 3. By automatically it is meant that the process or function is performed without any additional human involvement, except perhaps to initiate or authorize it.

Harvester control logic 236 can also generate harvester/front control signals that can be used to automatically control functions on the harvester 102 or other equipment on one or more different fronts. For instance, route controller 240 illustratively generates route control signals that can be sent to a navigation system in harvester 102 (or other equipment) so that the harvester 102 (or other equipment) is automatically controlled to follow a desired route. By way of example, it may be that a particular route will increase or decrease the harvest rate (in tons per hour or tons per hectare, etc.) of a harvester because the estimated yield for that route increases or decreases over that of the current route of harvester 102. Thus, the harvester may be directed to a particular route in order to increase or decrease its own harvest rate so the overall harvest rate of the fronts and fields, is maintained. The route information may also indicate that a truck 112 is to take a particular route when transporting harvested material to mill 114. It can indicate that a tractor 108 or 110, pulling a billet wagon, should take a particular route to a particular harvester 102 in the field. All of these and other routes can be generated and used to control the equipment.

Speed controller 242 illustratively generates speed control signals that control the speed of harvester 102 or other equipment. For instance, if the harvest rate of a front is going to decrease (because the front is relocating to a different field, for example), then the harvest rate of the remaining harvesters may need to be increased in order to maintain the overall harvest rate of material being transported to the mill 114. In that case, speed controller 242 generates speed control signals to automatically increase the speed of the harvesters in the remaining fronts to make up for the loss in harvest rate due to the relocation of the first front. In addition, if it is detected that a billet wagon being pulled by tractor 108 is almost full, then the speed controller 242 can generate speed control signals to increase the speed of tractor 110, traveling back to harvester 102, so that it can be in place to catch harvested material so that harvester 102 need not stop or idle, to wait for a billet wagon. Speed controller 242 can generate speed control signals in other ways. Harvester control logic 236 can also generate other harvester/equipment control signals. Generating the harvester/equipment control signals is indicated by block 274 in the flow diagram of FIG. 3.

Performing processing to identify control parameters in generating control signals can take a wide variety of other forms as well. This is indicated by block 276 in the flow diagram of FIG. 3.

Harvester control computing system 120 continues to detect near real time data from the harvesters, operators, and other equipment or sources. This is indicated by block 278. It continues to calculate or detect a current harvest rate as indicated by block 280 and it can also compare that to the desired target rate as indicated by block 282. It can continue to detect near real time data in other forms as well, and this is indicated by block 284.

If a modification is needed (because the current harvest rate differs from the target rate for some reason) as indicated by block 286, then processing illustratively returns to block 260 where processing, based upon the currently detected information, is performed, and the control parameters are generated as are the control signals to bring the harvest rate within a threshold value of the target rate. This continues, in one example, until the harvesting operation is complete. This is indicated by block 282 in the flow diagram of FIG. 3.

FIG. 4 is a flow diagram illustrating one example of the operation of yield data generation system 160. Field identification logic 180 first identifies a number of fields that are being harvested, and for which the harvest rate is being controlled. This is indicated by block 290 in the flow diagram of FIG. 4. The fields can be identified in a number of different ways. For instance, they can be identified by geographic location 292, and/or by any number of different unique identifiers (such as shape, geographical boundaries, etc.). This is indicated by block 294. They can be identified based on satellite or drone images, as indicated by block 296. They can be identified from stored geographic records as indicated by block 298, or in other ways as indicated by block 300.

Once the set of fields being harvested has been identified, harvest selector logic 196 illustratively selects a field for processing. This is indicated by block 202. It reads the geolocation and unique identifier information for the selected field and then current metric generator logic 184 determines whether a current yield prediction or metric (indicative of a current yield or estimated yield for this field) can be obtained or generated. Reading the geolocation and unique identifier information is indicated by block 304 and determining whether a current yield metric can be obtained or generated is indicated by block 306.

By way of example, it may be that a process has already been performed where a yield map has been generated for this field, and may indicate an estimated yield for this field. For instance, it may be that a remote imaging system (such as a drone or satellite) has taken visual images, and those images have been processed in order to identify a likely yield for this field. The likely yield can be generated on a per field basis, or as a yield map for smaller sections within a field. In another example, the yield map may not yet exist, but a drone or other image capturing mechanism is controlled to capture images so that the yield metric can be generated for this field, or for individual sections of the field. The current yield metric can be generated or obtained in a wide variety of other ways as well. Obtaining or generating a current yield estimate metric (such as in tons per hectare) is indicated in block 308. Generating that by retrieving a current yield map is indicated by block 310. Generating it by obtaining drone or other data and generating the metric based on that data is indicated by block 312. Generating or obtaining the current yield estimation metric in other ways is indicated by block 314.

If, at block 306, it is determined that a current yield prediction metric for the field, or for locations within the field, cannot be obtained or generated, then historic yield logic 186 controls data store interaction logic 158 to determine whether there is any historic yield data 172 for this field. This is indicated by block 316 in the flow diagram of FIG. 4. If so, then logic 186 controls logic 158 to retrieve the historic yield data for this field. This is indicated by block 318.

If, at block 316, it is determined that there is no historic yield data available for this field, then estimation logic 188 prompts an operator or other user for, or obtains from other sources, metric estimation inputs. By way of example, it may prompt an operator of a harvester to input an indication of the current yield level being observed in the field, or to estimate a yield level. It may have the operator put in other plant metrics, weather metrics, etc. It can generate a yield metric estimation based upon a variety of other information, such as weather data obtained over a wide area network, vehicle sensors (such as a camera or other image capture mechanism and image processing logic, etc.), and/or the operator inputs. This is indicated by block 320 in the flow diagram of FIG. 4.

Once one or more yield metrics are generated for the current field, then field selector 182 determines whether there are more fields to be considered in this harvesting process. This is indicated by block 322. If so, processing reverts to block 302 where a next field is selected.

When all fields have been considered, system 160 controls yield model 190 to generate and output yield data based upon the yield metrics generated for the various fields. This is indicated by block 324. The yield metrics can be at the field level (e.g., an estimated yield for the entire field). This is indicated by block 326. In that case, there may be a separate metric for each field that has been considered, or the metrics may be aggregated into a single metric for all of the fields.

The metrics may be for different spatial or geographic parts of the individual fields being considered. This is indicated by block 328. This type of yield information is more granular so that a current yield rate can be identified more accurately. By way of example, if a front in one field is operating in a particularly high yield portion of the field, then it may be beneficial to move another front in another field to operate in a lower yield portion of that field so that the overall harvesting rate can be maintained relatively constant. This is just one example of how the yield information for different geographic locations within the different fields can be used. Controlling the yield model to generate and output yield data based on the yield metrics can be done in a wide variety of other ways as well. This is indicated by block 330 in the flow diagram of FIG. 4.

FIG. 5 is a flow diagram illustrating one example of the operation of harvest performance data generation system 162, in more detail. Harvester identification logic 194 first detects the number of harvesters used in the harvesting operation under consideration. This is indicated by block 332 in the flow diagram of FIG. 5. The harvesters can be identified by machine model and configuration. This is indicated by block 334. Harvester identification logic 194 can control data store interaction logic 158 to obtain the harvester identification information from data store 154, as indicated by block 336, or it can be obtained by operator inputs, manager inputs, or other user inputs, as indicated by block 338. The harvesters involved in the harvesting operation under consideration can be identified or detected in a wide variety of other ways as well. This is indicated by block 340.

Harvester selector logic 196 then selects one of the identified harvesters as indicated by block 342, and productivity factor logic 198 identifies or detects other factors that bear on the productivity of that particular harvester. This is indicated by block 344. For instance, productivity factor logic 198 may identify the particular field 346 that the harvester is operating in. It may detect field conditions 348 (such as topology, soil type, soil moisture, etc.). It may detect the operator 350 of the harvester, and a wide variety of other factors 352 that may bear on how productive this particular, selected harvester will be in the harvesting operation.

Historic performance logic 200 then controls data store interaction logic 158 to determine whether any historic performance data 174 is available for this harvester. This is indicated by block 354. If so, estimation logic 202 obtains or generates a productivity metric (e.g., in tons per hour) for this selected machine. This is indicated by block 356. The productivity metric may be a general productivity metric for this machine, regardless of where, and under what conditions, it is operating. This is indicated by block 358. It may be a more specific productivity metric indicating productivity under the current field conditions for this particular field (or for a similar field). This is indicated by block 360. It may be a productivity metric that is dependent upon the selected machine being operated by an identified operator. This is indicated by block 362. For instance, it may be that certain operators operate a particular type of machine with a particular configuration more efficiently than other operators. Therefore, the productivity metric for this harvester may actually be for the harvester/operator combination. The productivity metric may be divided out for different field sections as well. This is indicated by block 364. For instance, it may be that the productivity of this machine will increase or decrease based upon the particular section that it is used to harvest. The metrics may indicate this. The metrics may be obtained or generated in a wide variety of other ways as well, and this is indicated by block 366.

If no historic performance data 174 is available for this harvester, then estimation logic 202 generates an estimate of the productivity metric for this machine, such as based upon the productivity factors identified by productivity factor logic 198, or in other ways. Generating or estimating the productivity metric is indicated by block 366.

Once a productivity metric (or a set of metrics) is generated for this harvester, then harvester selector logic 196 determines whether there are more harvesters to consider in this harvesting operation. This is indicated by block 368. If so, then processing reverts to block 342 where it selects another harvester.

Once productivity metrics have been generated for each of the harvesters involved in the harvesting operation, then system 162 controls productivity model 204 to generate and output harvest performance data based upon the various productivity metrics. This is indicated by block 370. The productivity data can be output on a per-harvester basis, or it can be aggregated across all of the harvesters being considered. Similarly, it can be aggregated across subsets of harvesters (such as those operating in the same field, etc.). It can break the data down further, into more granular sets, such as productivity data for a particular harvester or set of harvesters in particular sections of a given field, under the current conditions with the current operator. If the conditions change, then the system may update the productivity data. This is just one example.

FIG. 6 is a flow diagram illustrating one example of the operation of logistics performance data generation system 164, in more detail. Resource detection logic 208 first detects a number of logistics resources that are used in performing the harvesting operation under consideration. This is indicated by block 372 in the flow diagram of FIG. 6. For instance, it can identify the particular machines being used, as indicated by block 374. It can identify the operators of those machines as indicated by block 376. It can identify how the machines and operators are grouped in fronts, as indicated by block 378. It can identify the logistics resources in a wide variety of other ways as well, and this is indicated by block 380.

In identifying this information, resource detection logic 208 can receive operator inputs identifying the resources, manager inputs identifying the resources, or it can control data store interaction logic 158 to retrieve that information from data store 154, or elsewhere. For instance, it may be that a manager has already determined which particular machines and operators will be involved, and how those machines and operators will be grouped together in the various fronts.

Once the resources are identified, resource selector logic 240 selects a set of logistics resources for analysis. This is indicated by block 382. By way of example, it may select the resources that are on a particular front, or the resources that are being deployed to a particular field or section of a field, etc.

Logistics factor logic 212 then detects or obtains other logistics performance factors (e.g., factors that may bear on the logistics performance of the selected set of resources). This is indicated by block 384. By way of example, it may identify which particular field the resources are harvesting in. This is indicated by block 386. It may identify the field conditions, weather conditions, etc., under which the harvesting operation is taking place. This is indicated by block 388. It may detect or identify a wide variety of other logistics performance factors as well. This is indicated by block 390.

Historic logistics performance logic 214 then determines whether there is any historic logistics performance data 176 for the selected set of logistics resources. This is indicated by block 392. If so, then it obtains or generates a logistics performance metric (or set of metrics) for this set of logistics resources. This is indicated by block 394. In one example, the logistics performance metric (or metrics) is a measure of the percent of time that this set of resources will actually be performing harvesting operations (as opposed to sitting idle for various reasons, redeploying to different geographic locations, etc.). Generating the logistics performance metric as a measure of productive time is indicated by block 396.

The productivity metrics may be generated as general metrics, or they may be broken into metrics that are applied under different conditions. For instance, there may be a logistics performance metric for a first field, under a first set of field conditions, but a different logistics performance metric for a different field, or for a different set of field conditions. Generating logistics performance metrics for operation under different field or crop conditions is indicated by block 398. Generating different metrics for different fields or field sections is indicated by block 400. The logistics performance metric for the selected set of resources can be done in other ways as well, and this is indicated by block 402. If no logistics performance data 176 is available for this set of resources, then estimation logic 216 illustratively generates an estimate of the logistics performance metric (or metrics) based upon the logistics performance factors or other information. This is indicated by block 404.

Once the logistics performance metrics have been generated for this set of resources, then resource selector logic 210 determines whether there are more resources to be considered. This is indicated by block 406. If so, processing returns to block 382 where logic 240 selects another set of logistics resources for processing.

Once all of the sets of logistics resources have been considered, then system 164 controls logistics performance model 218 to generate and output the logistics performance data (such as the percent of time that the resources will be productive). This is indicated by block 408. Logistics performance data can be output for all of the resources, in general, or it can be broken up into different sets of resources (such as different fronts, different harvesters, different fields, or it can be broken up in other ways).

As discussed above with respect to FIG. 3, once the yield data, harvester performance data and logistics performance data have been generated, they are provided to control parameter generation system 166 where control parameters are identified or generated and provided to control signal generator system 168. System 168 generates the control signals, some of which are discussed above, to control the various items in order to maintain a relatively consistent flow rate of harvested material to mill 114.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

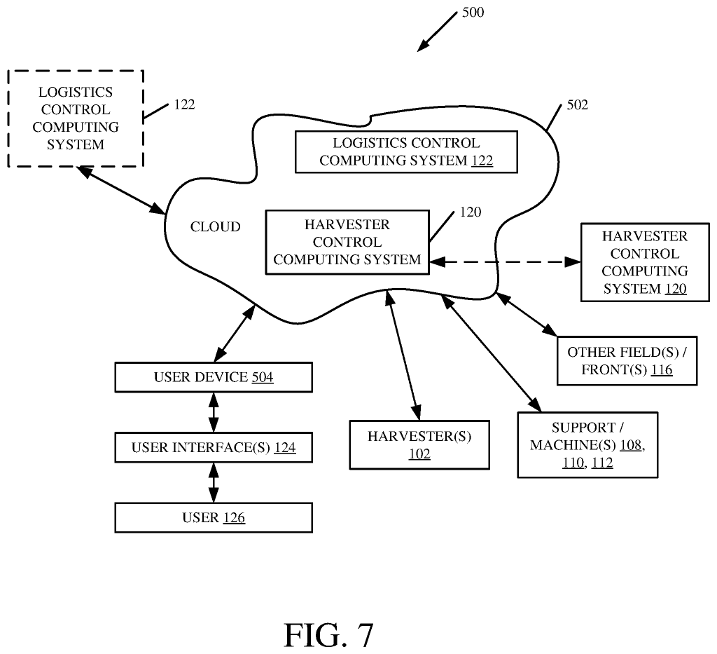

FIG. 7 is a block diagram of architecture 100, shown in FIG. 1, except that it is in a remote server architecture 500. In one example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in FIG. 1 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 7, some items are similar to those shown in FIG. 1 and they are similarly numbered. FIG. 7 specifically shows that harvest control computing system 120 and logistics control computing system 122 can be located at a remote server location 502. Therefore, harvester 102 and user 126 and the operators of other vehicles access those systems through remote server location 502.

FIG. 7 also depicts another example of a remote server architecture. FIG. 7 shows that it is also contemplated that some elements of FIG. 1 are disposed at remote server location 502 while others are not. By way of example, system 120 and/or system 122, or other items, can be disposed at a location separate from location 502, and accessed through the remote server at location 502. Regardless of where they are located, they can be accessed directly by harvester 102 or the other items, through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the harvester 102 comes close to the fuel truck for fueling, the system automatically collects the information from the harvester using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the harvester until the harvester enters a covered location. The harvester, itself, can then send the information to the main network.

It will also be noted that the elements of FIG. 1, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc. For instance, the operators of the various vehicles can communicate with architecture 100, and receive control signals, using mobile devices.

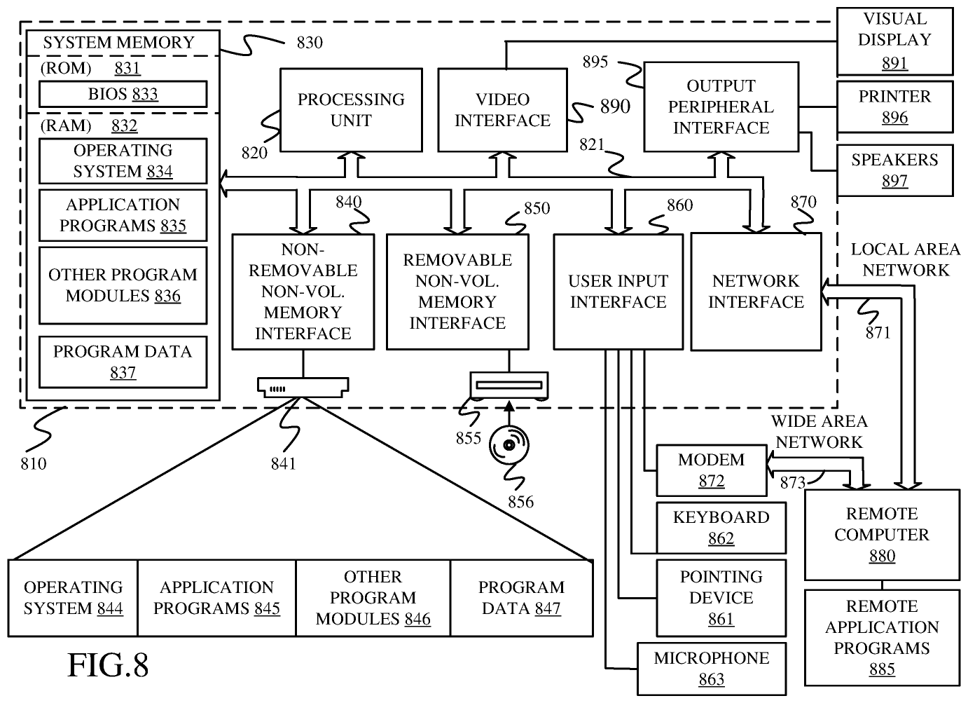

FIG. 8 is one example of a computing environment in which elements of FIG. 1, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network—LAN, controller area network—CAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 8 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Example 1 is a control computing system, comprising:

a yield data generation system that generates yield data corresponding to a set of fields being harvested by a set of harvesters;

a harvester performance data generation system that generates harvester performance data, indicative of an estimated rate of harvested material harvested by the set of harvesters;

a logistics performance data generation system that generates logistics performance data indicative of a likely proportion of time the set of harvesters will be engaged in productive harvesting;

a control parameter generation system that detects a target harvest rate, indicative of a target rate at which harvested material is harvested, and that generates a set of control parameters based on the target harvest rate, the yield data, the harvester performance data and the logistics performance data; and

a control signal generator system that generates a set of harvester control signals, based on the control parameters.

Example 2 is the control computing system of any or all previous examples wherein the control signal generator system is configured to generate the set of harvester control signals to control the set of harvesters to maintain a harvest rate within a threshold range of the target harvest rate.

Example 3 is the control computing system of any or all previous examples wherein the control signal generator system comprises:

harvester control logic configured to generate harvester control signals to control at least one harvester in the set of harvesters to maintain a desired harvest rate.

Example 4 is the control computing system of any or all previous examples wherein the harvester control logic comprises:

a route controller configured to generate, as the set of harvester control signals, route information indicative of a commanded route for the at least one harvester and provide the route information for a navigation system on the at least one harvester.

Example 5 is the control computing system of any or all previous examples wherein the harvester control logic comprises:

a speed controller configured to generate harvester speed control signals to control a speed of the at least one harvester.

Example 6 is the control computing system of any or all previous examples wherein the set of harvesters are supported by a set of support vehicles and wherein the route controller is configured to generate support vehicle route information indicative of a commanded route at least one support vehicle and provide the support vehicle route information to the at least one support vehicle.

Example 7 is the control computing system of any or all previous examples wherein the speed controller is configured to generate support vehicle speed control signals to control a speed of the at least one support vehicle.

Example 8 is the control computing system of any or all previous examples and further comprising:

a communication system configured to communicate the harvester control signals to the at least one harvester; and

a communication controller configured to generate communication control signals that control the communication system to send the harvester control signals to the at least one harvester for interaction by an operator of the at least one harvester.

Example 9 is the control computing system of any or all previous examples wherein the set of fields being harvested comprises a plurality of different fields each being harvested by a different harvester, in the set of harvesters, and wherein the control parameter generation system comprises:

field sequence identifier logic that generates, as a control parameter, a field sequence indicative of an ordered sequence of fields from which harvested material is to be transported to a processing facility.

Example 10 is the control computing system of any or all previous examples wherein the control parameter generation system comprises:

a road transport factor detector configured to detect road transport factors, the field sequence identifier logic being configured to generate the field sequence based on the road transport factors.

Example 11 is a method of controlling a set of harvesters, comprising:

generating yield data corresponding to a set of fields being harvested by the set of harvesters;

generating harvester performance data, indicative of an estimated rate of harvested material harvested by the set of harvesters;

generating logistics performance data indicative of a likely proportion of time the set of harvesters will be engaged in productive harvesting;

detecting a target harvest rate, indicative of a target rate at which harvested material is harvested;

generating a set of control parameters based on the target harvest rate, the yield data, the harvester performance data and the logistics performance data; and

generating a set of harvester control signals, based on the control parameters.

Example 12 is the method of any or all previous examples wherein generating yield data comprises:

generating separate yield data for each field in the set of fields.

Example 13 is the method of any or all previous examples wherein generating yield data comprises:

generating yield data for individual sections of each field in the set of fields.

Example 14 is the method of any or all previous examples wherein generating yield data comprises:

controlling data store accessing logic to access at least one of a yield map and historic yield data corresponding to the set of fields in a data store; and

generating the yield data based on the at least one of a yield map and historic yield data corresponding to the set of fields.

Example 15 is the method of any or all previous examples wherein generating harvester performance data comprises:

generating harvester performance data indicative of a likely rate of harvested material harvested by each harvester.

Example 16 is the method of any or all previous examples wherein generating harvester performance data comprises:

identifying an operator for each harvester; and

generating harvester performance data for each harvester/operator pair.

Example 17 is the method of any or all previous examples wherein generating harvester performance data comprises:

identifying a field in which each harvester/operator pair is harvesting, as a harvester/operator/field combination; and

generating the harvester performance data for each harvester/operator/field combination.

Example 18 is the method of any or all previous examples wherein each given harvester is part of a front of resources that includes the given harvester and a corresponding set of support vehicles and wherein generating logistics performance data comprises:

generating logistics performance data for each front.

Example 19 is the method of any or all previous examples wherein each front has a set of operators and is deployed to a field and wherein generating logistics performance data comprises:

generating logistics performance data for each combination of front, set of operators, and field.

Example 20 is a control computing system, comprising:

a yield data generation system that generates yield data corresponding to a set of fields being harvested by a set of harvesters;

a harvester performance data generation system that generates harvester performance data, indicative of an estimated rate of harvested material harvested by the set of harvesters;

a logistics performance data generation system that generates logistics performance data indicative of a likely proportion of time the set of harvesters will be engaged in productive harvesting;

a control parameter generation system that detects a target harvest rate, indicative of a target rate at which harvested material is harvested, and that generates a set of control parameters based on the target harvest rate, the yield data, the harvester performance data and the logistics performance data; and

a control signal generator system that generates a set of harvester control signals, based on the control parameters to control the set of harvesters to maintain a harvest rate within a threshold range of the target harvest rate.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A control computing system, comprising:
a yield data generation system that generates yield data corresponding to a set of fields being harvested by a set of harvesters;
a harvester performance data generation system that generates harvester performance data, indicative of an estimated rate of harvested material harvested by the set of harvesters;
a logistics performance data generation system that generates logistics performance data indicative of a likely proportion of time the set of harvesters will be engaged in productive harvesting;
a control parameter generation system that detects a target harvest rate, indicative of a target rate at which harvested material is harvested, and that generates a set of control parameters based on the target harvest rate, the yield data, the harvester performance data and the logistics performance data; and
a control signal generator system that generates a set of harvester control signals, based on the control parameters.

2. The control computing system of claim 1 wherein the control signal generator system is configured to generate the set of harvester control signals to control the set of harvesters to maintain a harvest rate within a threshold range of the target harvest rate.

3. The control computing system of claim 2 wherein the control signal generator system comprises:
harvester control logic configured to generate harvester control signals to control at least one harvester in the set of harvesters to maintain a desired harvest rate.

4. The control computing system of claim 3 wherein the harvester control logic comprises:
a route controller configured to generate, as the set of harvester control signals, route information indicative of a commanded route for the at least one harvester and provide the route information for a navigation system on the at least one harvester.

5. The control computing system of claim 4 wherein the harvester control logic comprises:
a speed controller configured to generate harvester speed control signals to control a speed of the at least one harvester.

6. The control computing system of claim 5 wherein the set of harvesters are supported by a set of support vehicles and wherein the route controller is configured to generate support vehicle route information indicative of a commanded route at least one support vehicle and provide the support vehicle route information to the at least one support vehicle.

7. The control computing system of claim 5 wherein the speed controller is configured to generate support vehicle speed control signals to control a speed of the at least one support vehicle.

8. The control computing system of claim 3 and further comprising:
a communication system configured to communicate the harvester control signals to the at least one harvester; and
a communication controller configured to generate communication control signals that control the communication system to send the harvester control signals to the at least one harvester for interaction by an operator of the at least one harvester.

9. The control computing system of claim 1 wherein the set of fields being harvested comprises a plurality of different fields each being harvested by a different harvester, in the set of harvesters, and wherein the control parameter generation system comprises:
field sequence identifier logic that generates, as a control parameter, a field sequence indicative of an ordered sequence of fields from which harvested material is to be transported to a processing facility.

10. The control computing system of claim 9 wherein the control parameter generation system comprises:
a road transport factor detector configured to detect road transport factors, the field sequence identifier logic being configured to generate the field sequence based on the road transport factors.

11. A method of controlling a set of harvesters, comprising:
generating yield data corresponding to a set of fields being harvested by the set of harvesters;
generating harvester performance data, indicative of an estimated rate of harvested material harvested by the set of harvesters;
generating logistics performance data indicative of a likely proportion of time the set of harvesters will be engaged in productive harvesting;
detecting a target harvest rate, indicative of a target rate at which harvested material is harvested;
generating a set of control parameters based on the target harvest rate, the yield data, the harvester performance data and the logistics performance data; and
generating a set of harvester control signals, based on the control parameters.

12. The method of claim 11 wherein generating yield data comprises:
generating separate yield data for each field in the set of fields.

13. The method of claim 12 wherein generating yield data comprises:
generating yield data for individual sections of each field in the set of fields.

14. The method of claim 11 wherein generating yield data comprises:
controlling data store accessing logic to access at least one of a yield map and historic yield data corresponding to the set of fields in a data store; and
generating the yield data based on the at least one of a yield map and historic yield data corresponding to the set of fields.

15. The method of claim 11 wherein generating harvester performance data comprises:
generating harvester performance data indicative of a likely rate of harvested material harvested by each harvester.

16. The method of claim 15 wherein generating harvester performance data comprises:
identifying an operator for each harvester; and
generating harvester performance data for each harvester/operator pair.

17. The method of claim 16 wherein generating harvester performance data comprises:
identifying a field in which each harvester/operator pair is harvesting, as a harvester/operator/field combination; and
generating the harvester performance data for each harvester/operator/field combination.

18. The method of claim 11 wherein each given harvester is part of a front of resources that includes the given harvester and a corresponding set of support vehicles and wherein generating logistics performance data comprises:
generating logistics performance data for each front.

19. The method of claim 18 wherein each front has a set of operators and is deployed to a field and wherein generating logistics performance data comprises:
generating logistics performance data for each combination of front, set of operators, and field.

20. A control computing system, comprising:
a yield data generation system that generates yield data corresponding to a set of fields being harvested by a set of harvesters;
a harvester performance data generation system that generates harvester performance data, indicative of an estimated rate of harvested material harvested by the set of harvesters;
a logistics performance data generation system that generates logistics performance data indicative of a likely proportion of time the set of harvesters will be engaged in productive harvesting;
a control parameter generation system that detects a target harvest rate, indicative of a target rate at which harvested material is harvested, and that generates a set of control parameters based on the target harvest rate, the yield data, the harvester performance data and the logistics performance data; and
a control signal generator system that generates a set of harvester control signals, based on the control parameters to control the set of harvesters to maintain a harvest rate within a threshold range of the target harvest rate.
